(19) United States
(12) Patent Application Publication
(10) Pub. No.: US 2002/0169959 A1
(43) Pub. Date: Nov. 14, 2002

(54) Method and system for assuring security of an IC card

(76) Inventor: Meng-Lan Hsu, Taipei (TW)

Correspondence Address: Keith Kline, PRO-TECHTOR INTERNATIONAL SERVICES, 20775 Norada Court, Saratoga, CA, 95070-3018, US

(21) Appl. No.: 09/858,004

(22) Filed: May 14, 2001

(51) Int. Cl. H04L 9/00

(52) U.S. Cl. 713/169

(57) ABSTRACT

A verification method an system for assuring security of card encryption code in an IC card disclosed. Before the user inputs a card encryption code (PIN), a reader microcontroller unit serves to interrupt the data transmission between the keyboard and the computer so that the card encryption code verification system and the computer are independent to prevent that the card encryption code from entering into the computer system. Thus, the security of the card encryption code is assured.

### FIELD OF THE INVENTION

The present invention relates to a verification method and system for assuring security of card encryption code in an IC card, in particular to the user inputs a card encryption code (such as PIN), a gate serves to interrupt the data transmission between the keyboard and the computer.

### BACKGROUND OF THE INVENTION

With the application of the privacy and the financial system, the security and convenience of IC card are more and more important, especially, in the future, the network certificate and payment system will become a primary leader in the application. Therefore, before it is used widely, the securities of the current system and device must be analyzed, otherwise, as all the data is processed through a transferring medium (such as IFD-Interface device), the individual data could be intercepted by the transmitting medium so that the individual data or IC card is not protected. Conventionally, the IC card is read or written by a computer through a reader. In general, a reader has no complete independent function. Referring to FIG. 1, a prior art system is illustrated, in that, all the applications are performed through a PC. All the IC cards must be operated through a standard verification process, as illustrated in FIG. 2. In the terminal verification process, the false or truth of the IC card must be assured. The IC card verification process serves to assure the authority to the IC card from the reader. Most data in the IC card is protected through card encryption codes. When an IC card is used, the user must input the card encryption code. After the card encryption code is received by the computer, then the data of IC card is inputted through the reader. This is caused that the computer has the card encryption code of the user, and is possible to be downloaded by other intruder so that the protection to the data in the IC card is released.

### SUMMARY OF THE INVENTION

Accordingly, the primary object of the present invention is to provide a method and system for assuring security of an IC card. Thereby, the card encryption code verification system and the computer are independent so that the card encryption code of the user is protected in a safe condition. To achieve above object, the present invention provides a verification method for assuring security of card encryption code in an IC card, wherein the user inserts an IC card into a reader and then a terminal verification process and an IC card verification process are performed, comprising the steps of:

a. providing a gate for interrupting data transmission between a keyboard and a computer;

b. a reader microcontroller unit (Reader MCU) interrupting the data transmission between the keyboard and the computer;

c. the reader microcontroller unit displaying liquid crystal display to inform the user to input card encryption code;

d. receiving a card encryption code from the user through a keyboard;

e. the keyboard microcontroller unit (K/B MCU) transferring the card encryption code data to the reader microcontroller unit;

f. the reader microcontroller unit determining whether the number of the card encryption code is correct; if no, the process returning to step c; if yes, performing the following step;

g. the reader microcontroller unit transferring the card encryption code data to the IC card;

h. the IC card determining whether the card encryption code is correct; if no, the process returning to step b; if yes, the verification of the card encryption code is complete;

i. the reader microcontroller unit causing the data between the keyboard and the computer to be transmitted normally by the gate;

j. the computer providing services under authority to the user.

A verification system for about method comprising:

a gate for controlling data transmission between a keyboard and a computer;

a computer connected to the gate, after the verification of card encryption code, the computer providing services under authority;

a reader connected to the gate and a verification device; the reader including at least a reader microcontroller unit and a slot;

a keyboard connected to the gate and including at least one keyboard microcontroller; and

a verification device connected to the reader and for performing the terminal verification process and the IC card verification process;

When the user inserts the IC card into the reader; the reader microcontroller unit actuates the verification device to performs the terminal verification process and the IC card verification process and then reader microcontroller unit interrupts the data transmission between the keyboard and the computer by the gate; the card encryption code data inputted from the keyboard by the user is encoded by the keyboard microcontroller unit and then is transferred to the reader microcontroller unit; the reader microcontroller unit transfers the card encryption code data to the IC card for verification to prevent the card encryption code from entering into the computer.

The various objects and advantages of the present invention will be more readily understood from the following detailed description when read in conjunction with the appended drawing.

### BRIEF DESCRIPTION OF THE DRAWINGS

FIG. 1 shows a card verification device in the prior art.

FIG. 2 shows the flowchart of verifying an IC card in the prior art.

FIG. 3 shows the input of card encryption code and a verification process in the prior art.

FIG. 4 shows the system in the first embodiment of the present invention.

FIG. 5 shows the input of card encryption code and a verification process in the first embodiment of the present invention.

FIG. 6 shows the system in the second embodiment of the present invention.

FIG. 7 shows the input of card encryption code and a verification process in the second embodiment of the present invention.

### DETAILED DESCRIPTION OF THE PREFERRED EMBODIMENTS

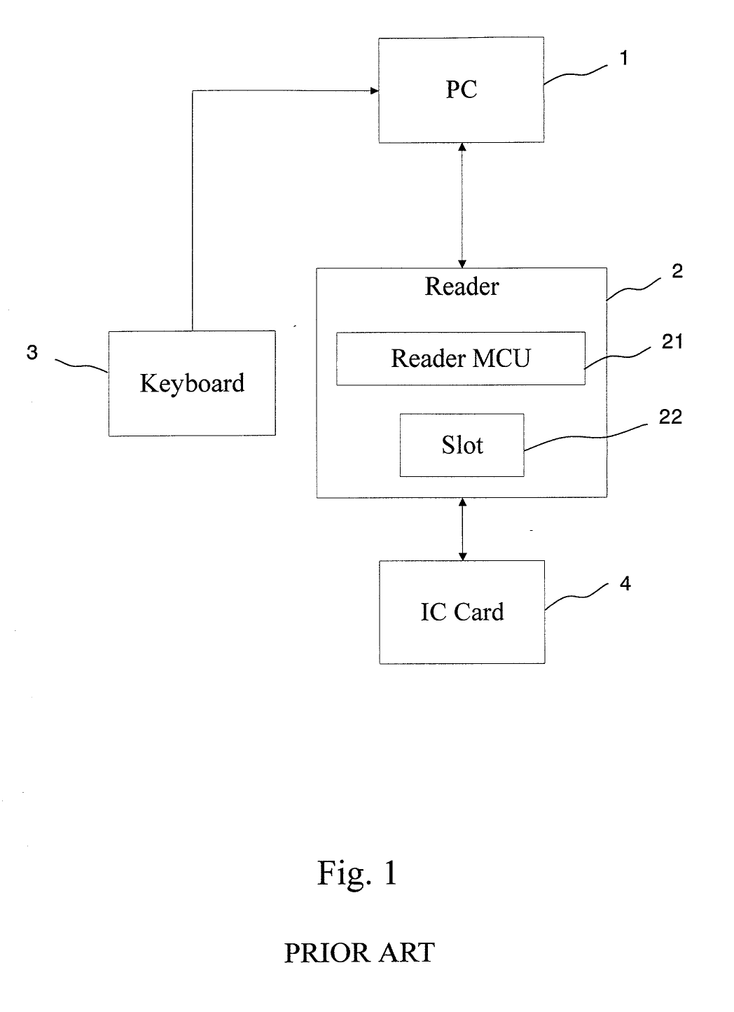

The present invention will be described in detail in the present invention with the appended figures. A prior art card verification device is illustrated in FIG. 1. Conventionally, the application of IC card 4 must be through a reader 2. Thereby, the computer 1 may read from or writer to the IC card. In general, the reader 2 has no complete independent function. All the function is performed through a computer 1. The reader 2 has a slot 22 for being inserted by an IC card 4. The reader microcontroller unit (Reader MCU) 21 has a function of transferring data between the computer 1 and the reader 2. The keyboard 3 serves to input card encryption code by the user, and through verification, the user may communicate with the computer 1 in the authority. The interfaces between the computer 1 and the reader 2 and between the computer 1 and the keyboard 3 are according to general used protocols, such as RS232, USB, PS/2, or parallel ports.

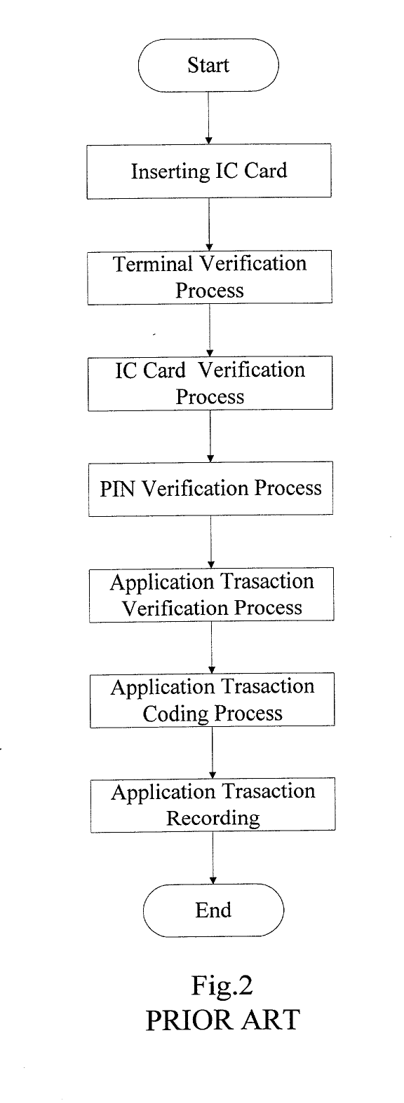

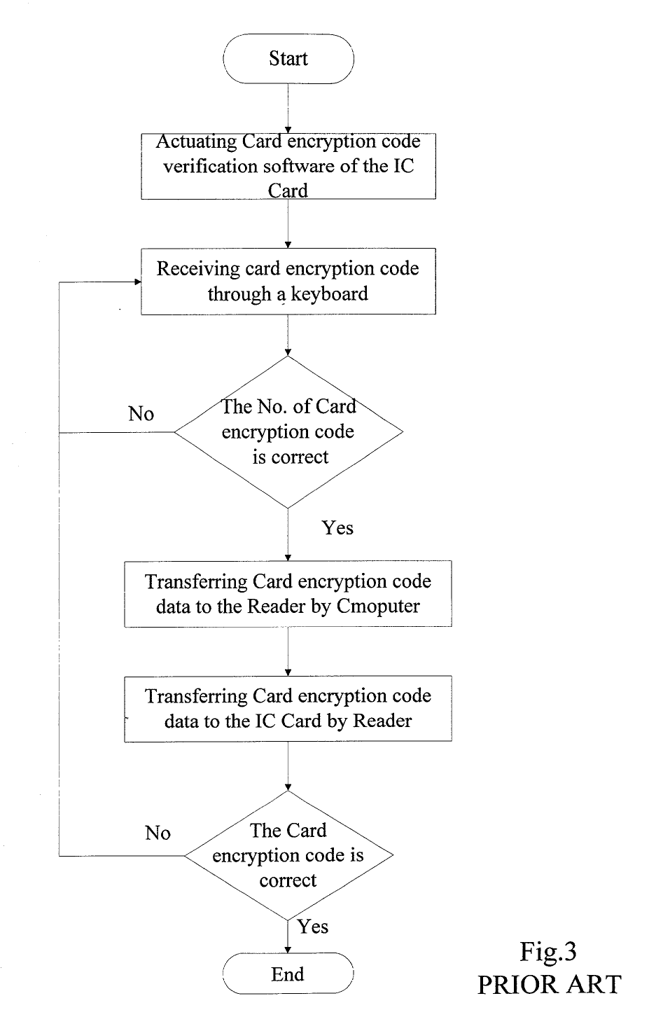

FIG. 2 shows the flowchart of a prior art IC card verifying process. In which a terminal verification process serves to verify whether the IC card is a correct one for preventing a false IC card from being inserted. In the IC card verification process, all the services in the main terminal is assured for preventing a false terminal from entering into an unauthority service. The aforesaid two processes (terminal verification process and IC card verification process) are performed within the computer 1. The card encryption code verification process serves to assure that the card owner is in transaction and all the data is processed through the allowance of the user so that the application transaction process, the application transaction coding process and the application transaction recording may generate effective data. Referring to FIG. 3, the card encryption code verification process is illustrated. The user inputs card encryption code through a keyboard 3. After the card encryption code is accepted by the computer 1, the data is inputted into IC card through the reader 2, Thereby, the computer 1 will retain the data of the card encryption code so that the owner of the IC card is not protected.

With reference to FIG. 3, the flowchart of the input and verification for the card encryption code is illustrated. The process comprises the steps of after the user completes a terminal verification process and an IC card verification process, actuating card encryption code verification software of the IC card 4; next, the user input card encryption code through a keyboard 3; then, the computer 1 assuring whether the card encryption code is correct. If no, the process returning to the step of inputting the card encryption code; if yes, continuing the process. Computer 1 transfers card encryption code data to the reader 2; then, the reader 2 re-transfers card encryption code data to the IC card 4. The card encryption code verification software of the IC card 4 determines whether the card encryption code is correct. If no, returning to the step of inputting card encryption code; if yes, completing the process of verifying card encryption code.

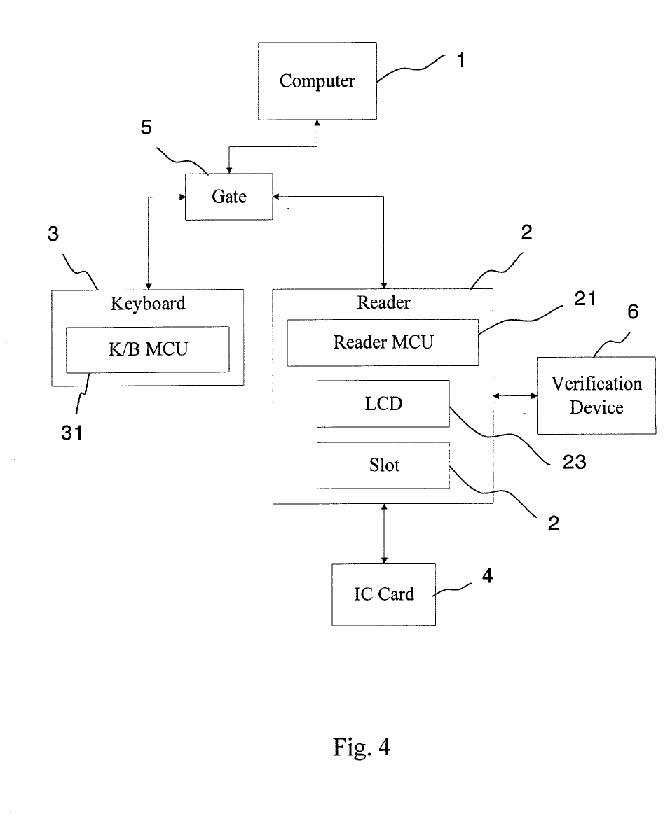

The system of the first embodiment in the present invention is illustrated in FIG. 4, which includes: a computer 1 (for example, a personal computer), after the verification of card encryption code, the computer 1 provides services under authority; a reader 2 including at least a reader microcontroller unit 21, a slot 22, and a liquid crystal display (LCD) 23, after the user inputs card encryption code, the liquid crystal display 23 will display the condition for informing the user; a keyboard 3 including at least one keyboard microcontroller (K/B MCU) 31, a gate 5 for controlling the data transmission between the keyboard 3 and the computer 1; a verification device 6 for performing the terminal verification process and the IC card verification process. The user inserts the IC card 4 into the reader 2. The reader microcontroller unit 21 actuates the verification device 6 to perform the terminal verification process and the IC card verification process and then reader microcontroller unit 21 interrupts the transmission of data between the keyboard 3 and the computer 1 by the gate 5. The card encryption code data inputted from the keyboard 3 by the user is encoded by the keyboard microcontroller unit 31 and then is transferred to the reader microcontroller unit 21. The reader microcontroller unit 21 transfers the card encryption code data to the IC card 4 for verification so as to prevent the card encryption code from entering into the computer 1. The interfaces between all the elements are based on general used protocols, such as RS232, USB, PS/2, or parallel ports.

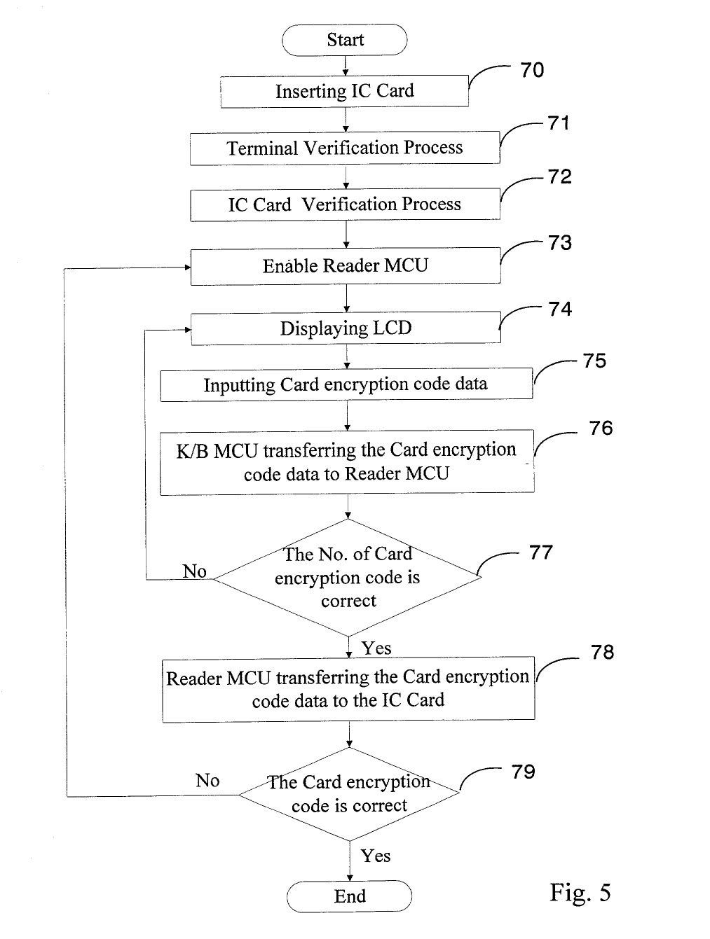

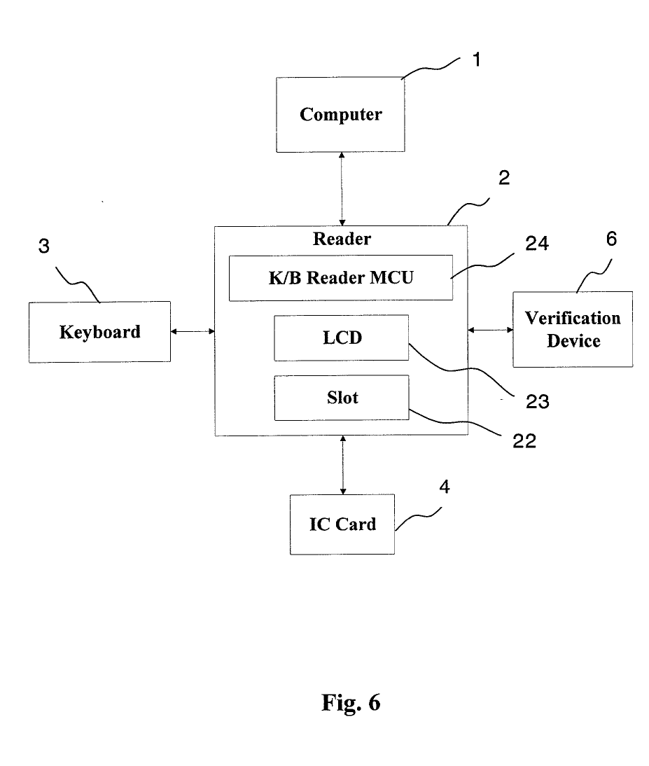

FIG. 5 is a flowchart of the input and verification process of the card encryption code data in the first embodiment of the present invention. With the hardware illustrated in FIG. 4, after user inserts the IC card 4 into the reader 2 (step 70); and passing through the terminal verification process (step 71) and IC card verification process (step 72), then performing the following process: reader microcontroller unit 21 interrupts the transmission of data between the keyboard 3 and the computer 1 by the gate 5 (step 73); the reader microcontroller unit 21 displays on the liquid crystal display 23 (step 74); user inputs the card encryption code data by keyboard 3 (step 75); keyboard microcontroller unit 31 transferring the card encryption code data to the reader microcontroller unit 21 (step 76); the reader microcontroller unit 21 determines whether the number of the card encryption code is correct (step 77); if no, the process returns to step 74; if yes, the reader microcontroller unit 21 transfers the card encryption code data to the IC card 4 (step 78); the IC card 4 determines whether the card encryption code is correct (step 79); if no, the process returns to step 73; if yes, the verification of the card encryption code is complete. Next, the reader microcontroller unit 21 causes the data between the keyboard 3 and the computer 1 to be transferred normally by the gate 5. The system of the second embodiment in the present invention is illustrated in FIG. 6, which includes: a computer 1 (for example, a personal computer), after the verification of card encryption code, the computer 1 provides services under authority; a reader 2 including at least a keyboard reader microcontroller unit (K/B Reader MCU) 24, a slot 22, and a liquid crystal display (LDC) 23, after the user inputs card encryption code, the liquid crystal display 23 will display the condition for informing the user; a keyboard 3; a verification device 6 for performing the terminal verification process and the IC card verification process. The user inserts the IC card 4 into the reader 2. The reader microcontroller unit 21 actuates the verification device 6 to perform the terminal verification process and the IC card verification process and then keyboard reader microcontroller unit 21 interrupts the transmission of data between the keyboard 3 and the computer 1. The card encryption code data inputted from the keyboard 3 by the user is transferred directly to the IC card 4 by keyboard reader microcontroller unit 24 for verification in order for preventing the card encryption code from entering into the computer 1. The interfaces between all the elements are based on-general used protocols, such as RS232, USB, PS/2, or parallel ports.

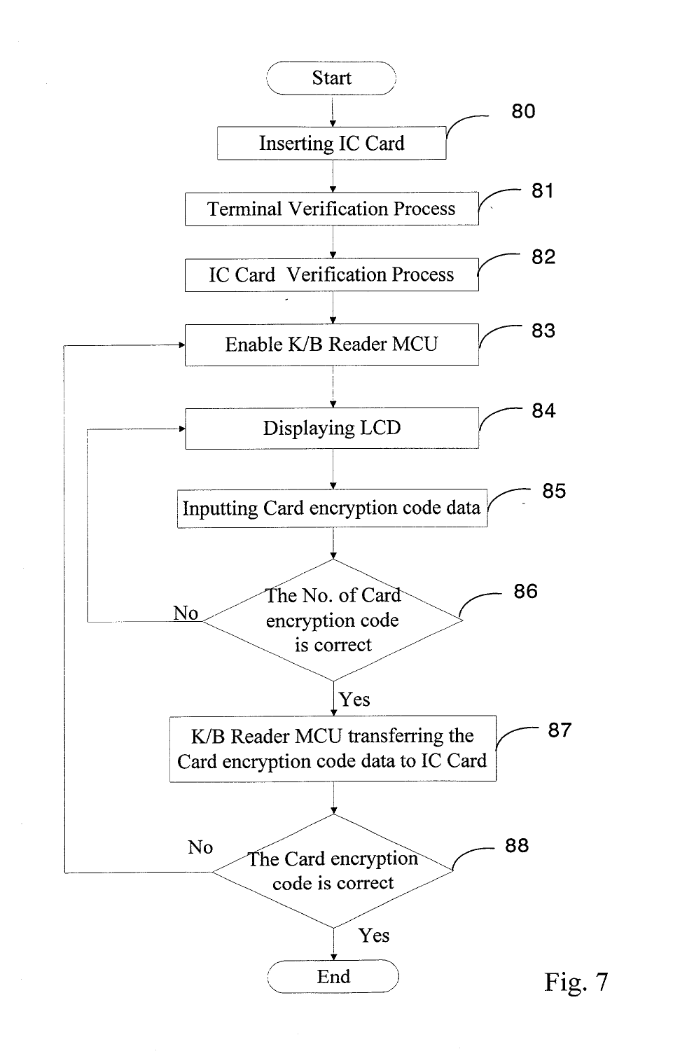

FIG. 7 is a flowchart of the input and verification process of the card encryption code data in the second embodiment of the present invention. With the system illustrated in FIG. 6, after the user inserts the IC card 4 into the reader 2 (step 80) and pass the terminal verification process (step 81) and IC card verification process (step 82), then performing the following process: keyboard reader microcontroller unit 24 interrupts the transmission of data between the keyboard 3 and the computer 1 (step 83); the keyboard reader microcontroller unit 24 displays on the liquid crystal display 23 (step 84); the user inputs the card encryption code data by the keyboard 3 (step 85); keyboard reader microcontroller unit 24 determines whether the number of the card encryption code is correct (step 86); if no, the process returns to step 84; if yes, the keyboard reader microcontroller unit 24 transfers the card encryption code data to the IC card 4 (step 87); the IC card 4 determines whether the card encryption code is correct (step 87); if no, the process returns to step 83; if yes, the verification of the card encryption code is complete. Next, the keyboard reader microcontroller unit 24 causes the data between the keyboard 3 and the computer 1 to be transferred normally.

Therefore, the present invention provides a method for assuring security of an IC card and the device of the same. Thereby, the card encryption code verification system and the computer are independent so that the card encryption code of the user is protected in a safe condition.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A verification method for assuring security of a card encryption code in an IC card, wherein the user inserts an IC card into a reader and then a terminal verification process and an IC card verification process are performed, comprising the steps of:
a. providing a gate;
b. interrupting the data transformation between the keyboard and the computer by a reader microcontroller unit (Reader MCU) through the gate;
c. displaying an message to inform the user to input card encryption code;
d. receiving a card encryption code from the user through a keyboard; and
e. transferring the card encryption code data to the reader microcontroller unit by the keyboard microcontroller unit (K/B MCU).

2. The verification method for assuring security of card encryption code in an IC card as claimed in claim 1, further comprising the steps of:
f. the reader microcontroller unit determining whether a number of the card encryption code is correct; if no, the process returning to step c;
if yes, performing the following step;
g. transferring the card encryption code data to the IC card by the reader microcontroller unit;
h. the IC card determining whether the card encryption code is correct; if no, the process returning to step b; if yes, the verification of the card encryption code is complete.

3. The verification method for assuring security of card encryption code in an IC card as claimed in claim 2, further comprising the steps of:
i. the reader microcontroller unit causing the data between the keyboard and the computer to be transferred normally by the gate; and
j. the computer providing services under authority to the user.

4. The verification method for assuring security of card encryption code in an IC card as claimed in claim 3, wherein the displayed message of the reader microcontroller unit is that the message is displayed on a liquid crystal display.

5. The verification method for assuring security of card encryption code in an IC card as claimed in claim 3, wherein the computer is a personal computer.

6. A verification method for assuring security of card encryption code in an IC card, wherein the user inserts an IC card into a reader and then a terminal verification process and an IC card verification process are performed, comprising the steps of:
a. interrupting data transformation between a keyboard and a computer by a keyboard reader microcontroller unit (K/B Reader MCU);
b. displaying an message to inform the user to input card encryption code;
c. receiving a card encryption code from the user through a keyboard; and
d. the keyboard reader microcontroller unit receiving the card encryption code.

7. The verification method for assuring security of card encryption code in an IC card as claimed in claim 6, further comprising the steps of:
e. the keyboard reader microcontroller unit determining whether the number of the card encryption code is correct; if no, the process returning to step b; if yes, performing the following step;
f. transferring the card encryption code data to the IC card by the reader microcontroller unit; and
g. the IC card determining whether the card encryption code is correct; if no, the process returning to step a; if yes, the verification of the card encryption code is complete.

8. The verification method for assuring security of card encryption code in an IC card as claimed in claim 7, further comprising the steps of:
h. causing the data between the keyboard and the computer to be transferred normally by the keyboard reader microcontroller unit;
i. the computer providing services under authority to the user.

9. The verification method for assuring security of card encryption code in an IC card as claimed in claim 8, wherein the displayed message of the keyboard reader microcontroller unit is that the message is displayed on a liquid crystal display.

10. The verification method for assuring security of card encryption code in an IC card as claimed in claim 8, wherein the computer is a personal computer.

11. A verification system for assuring security of card encryption code in an IC card, comprising:
a gate for controlling data transformation between a keyboard and a computer;
a computer connected to the gate, after the verification of card encryption code, the computer providing services under authority;
a reader connected to the gate and a verification device; the reader including at least a reader microcontroller unit and a slot; a keyboard connected to the gate and including at least one keyboard microcontroller, and
a verification device connected to the reader and for performing the terminal verification process and the IC card verification process;
wherein the user inserts the IC card into the reader; the reader microcontroller unit actuates the verification device to performs the terminal verification process and the IC card verification process; then the reader microcontroller unit interrupts the transformation of data between the keyboard and the computer by the gate; the card encryption code data inputted from the keyboard by the user is encoded by the keyboard microcontroller unit and then is transferred to the reader microcontroller unit; the reader microcontroller unit transfers the card encryption code data to the IC card for verification so as to prevent the card encryption code entering into the computer.

12. The verification system for assuring security of card encryption code in an IC card as claimed in claim 11, wherein the reader has a liquid crystal display; as the user inputs the card encryption code, the liquid crystal display is in a display condition for informing the user.

13. The verification system for assuring security of card encryption code in an IC card as claimed in claim 11, wherein the interfaces between all the elements are based on general used protocols, such as RS232, USB, PS/2, or parallel ports.

14. The verification system for assuring security of card encryption code in an IC card as claimed in claim 13, wherein the computer is a personal computer.

15. A verification system for assuring security of card encryption code in an IC card, comprising:
a computer, after the verification of card encryption code, the computer providing services under authority;
a reader connected to the computer, a keyboard and a verification device;
the reader including at least a keyboard reader microcontroller unit and a slot;
a keyboard connected to the reader; and
a verification device connected to the reader and for performing the terminal verification process and the IC card verification process;
wherein user inserted the IC card into the reader; the keyboard reader microcontroller unit actuates the verification device to perform the terminal verification process and the IC card verification process; then
the keyboard reader microcontroller unit interrupts the transformation of data between the keyboard and the computer; the card encryption code data inputted from the keyboard by the user is transferred directly to the IC card by keyboard reader microcontroller unit for verification so as to prevent the card encryption code from entering into the computer.

16. The verification system for assuring security of card encryption code in an IC card as claimed in claim 15, wherein the reader has a liquid crystal display; as the user inputs the card encryption code, the liquid crystal display is in a display condition for informing the user.

17. The verification system for assuring security of card encryption code in an IC card as claimed in claim 15, wherein the interfaces between all the elements are according to general used protocols, such as RS232, USB, PS/2, or parallel ports.

18. The verification system for assuring security of card encryption code in an IC card as claimed in claim 17, wherein the computer is a personal computer.
